(19) United States
(12) Patent Application Publication
(10) Pub. No.: US 2022/0114522 A1
(43) Pub. Date: Apr. 14, 2022

(54) Employee Retention Insight Generation

(71) Applicant: ADP, LLC, Roseland, NJ (US)

(72) Inventors: Eduardo Cardoso, Porto Alegre (BR); Alex Ferreira, Porto Alegre (BR); Leonardo Santos, Porto Alegre (BR); Jaquelini Rocha, Porto Alegre (BR)

(21) Appl. No.: 17/069,980

(22) Filed: Oct. 14, 2020

(51) Int. Cl. G06Q 10/06; G06Q 30/02; G06Q 10/10; G06Q 40/00; G06N 20/00; G06F 40/174

(52) U.S. Cl. CPC G06Q 10/06375; G06Q 30/0282; G06Q 10/1057; G06F 40/174; G06Q 10/06311; G06N 20/00; G06Q 40/125

(57) ABSTRACT

Generating employee retention insights is provided. An analysis is performed, using an artificial intelligence component, of data in a completed digital off-boarding form corresponding to a particular employer and a type of a particular employee leaving the particular employer and information in data feeds from a plurality of different data sources. Insights are generated, using the artificial intelligence component, into employee retention for the type of the particular employee corresponding to the particular employer based on the analysis of the data in the completed digital off-boarding form and the information in the data feeds from the plurality of different data sources. A set of action steps are generated, using the artificial intelligence component, based on the insights and the data in the completed digital off-boarding form. One or more of the set of action steps are performed automatically.

### BACKGROUND

### 1. Field

The disclosure relates generally to artificial intelligence and more specifically to generating insights into employee retention actions from employee off-boarding data using artificial intelligence.

### 2. Description of the Related Art

Artificial intelligence is an ability of a computer to perform tasks commonly associated with human intelligence, such as visual perception, speech recognition, decision-making, and the like. Artificial intelligence is frequently applied to systems endowed with intellectual processes, such as an ability to reason, discover meaning, generalize, and learn from past experience. Since the development of computers, it has been demonstrated that computers can be programmed to carry out very complex tasks.

Traditional goals of artificial intelligence include statistical analysis, perception, reasoning, knowledge representation, planning learning, natural language processing, and the like. Natural language processing allows computers to read and understand human language. Some applications of natural language processing include information retrieval, text mining, question answering, and machine translation.

Machine learning is also a fundamental concept of artificial intelligence. Machine learning improves automatically through experience. Unsupervised machine learning is an ability to find patterns in a stream of input, without requiring a human to label the inputs first. Supervised machine learning includes both classification and regression, which requires a human to label the input data first, known as training data, in order to make predictions or decisions without being explicitly programmed to do so. Classification is used to determine what category something belongs in, and occurs after a machine learning program sees a number of examples of things from several categories. Regression is the attempt to produce a function that describes the relationship between inputs and outputs and predicts how the outputs should change as the inputs change. In its application across business problems, machine learning is also referred to as predictive analytics.

### SUMMARY

According to one illustrative embodiment, a computer-implemented method for generating employee retention insights is provided. The computer, using an artificial intelligence component, performs an analysis of data in a completed digital off-boarding form corresponding to a particular employer and a type of a particular employee leaving the particular employer and information in data feeds from a plurality of different data sources. The computer, using the artificial intelligence component, generates insights into employee retention for the type of the particular employee corresponding to the particular employer based on the analysis of the data in the completed digital off-boarding form and the information in the data feeds from the plurality of different data sources. The computer, using the artificial intelligence component, generates a set of action steps based on the insights and the data in the completed digital off-boarding form. The computer performs one or more of the set of action steps automatically.

According to another illustrative embodiment, a computer system for generating employee retention insights is provided. The computer system comprises a bus system, a storage device storing program instructions connected to the bus system, and a processor executing the program instructions connected to the bus system. The computer system, using an artificial intelligence component, performs an analysis of data in a completed digital off-boarding form corresponding to a particular employer and a type of a particular employee leaving the particular employer and information in data feeds from a plurality of different data sources. The computer system, using the artificial intelligence component, generates insights into employee retention for the type of the particular employee corresponding to the particular employer based on the analysis of the data in the completed digital off-boarding form and the information in the data feeds from the plurality of different data sources. The computer system, using the artificial intelligence component, generates a set of action steps based on the insights and the data in the completed digital off-boarding form. The computer system performs one or more of the set of action steps automatically.

According to another illustrative embodiment, a computer program product for generating employee retention insights is provided. The computer program product comprises a computer readable storage medium having program instructions embodied therewith, the program instructions executable by a computer to cause the computer to perform a method. The computer, using an artificial intelligence component, performs an analysis of data in a completed digital off-boarding form corresponding to a particular employer and a type of a particular employee leaving the particular employer and information in data feeds from a plurality of different data sources. The computer, using the artificial intelligence component, generates insights into employee retention for the type of the particular employee corresponding to the particular employer based on the analysis of the data in the completed digital off-boarding form and the information in the data feeds from the plurality of different data sources. The computer, using the artificial intelligence component, generates a set of action steps based on the insights and the data in the completed digital off-boarding form. The computer performs one or more of the set of action steps automatically.

According to another illustrative embodiment, a method for generating employee retention insights is provided. An analysis is performed of data in a completed digital off-boarding form corresponding to a particular employer and a type of a particular employee leaving the particular employer and information in data feeds from a plurality of different data sources. Insights into employee retention are generated for the type of the particular employee corresponding to the particular employer based on the analysis of the data in the completed digital off-boarding form and the information in the data feeds from the plurality of different data sources. A set of action steps are automatically performed based on the insights and the data in the completed digital off-boarding form.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of an insight generation system in accordance with an illustrative embodiment; and

FIG. 4 is a flowchart illustrating a process for generating employee retention insights in accordance with an illustrative embodiment.

### DETAILED DESCRIPTION

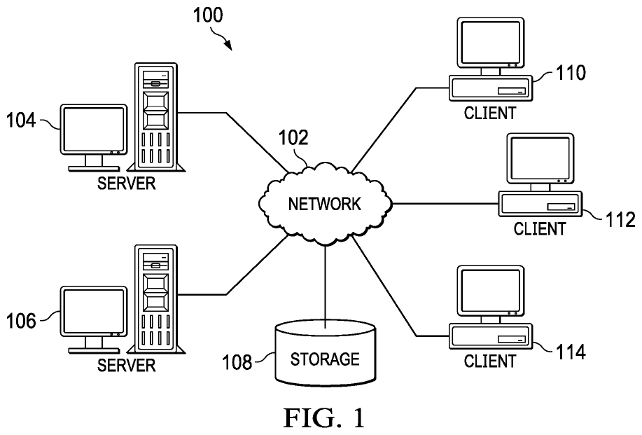

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide employee retention insight services to registered clients. It should be noted that server 104 and server 106 are owned and operated by a third-party entity, such as, for example, Automatic Data Processing, LLC of New Jersey, which is the provider of the employee retention insight services to a plurality of registered employer entities. Registered employer entities may include, for example, companies, enterprises, businesses, organizations, agencies, institutions, and the like.

Also, it should be noted that server 104 and server 106 may each represent a cluster of servers in one or more data centers. Alternatively, server 104 and server 106 may each represent multiple computing nodes in one or more cloud environments. Further, server 104 and server 106 may provide information, such as, for example, applications, programs, files, data, and the like to client 110, client 112, and client 114.

Client 110, client 112, and client 114 also connect to network 102. In this example, clients 110, 112, and 114 correspond to a particular employer entity and are registered clients of server 104 and server 106. The employer entity employs a multitude of employees consisting of different types, such as, for example, laborers, workers, administrative staff, managers, executives, officers, and the like.

In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart televisions, and the like, with wire or wireless communication links to network 102.

Users of clients 110, 112, and 114 (i.e., employees of the employer) may utilize clients 110, 112, and 114 to access the employee retention services provided by server 104 and server 106. For example, a human resource employee may utilize client 110 to start an employee off-boarding process when a particular employee is leaving the employer and to input data into a digital employee off-boarding form during or after conducting an exit interview with that particular employee. In addition, the employee may utilize another client, such as client 112, to also input data into the digital employee off-boarding form prior to, during, or after participating in the exit interview with the human resource employee.

Server 104 and server 106, using artificial intelligence, analyze the employee off-boarding data contained in the employee off-boarding form and information contained in a plurality of different data sources to generate a set of employee retention insights. The plurality of different data sources may include, for example, a database of the employer containing human resource data corresponding to the employer's employees, third-party databases containing employer rating and ranking data obtained from current and/or former employees using surveys, a database of the employee retention insight services provider containing historical employee off-boarding data, and the like. The set of employee retention insights may include, for example, steps for decreasing employee turnover for a particular position, steps for increasing employee career growth, steps to implement new employee benefit plans, and the like.

Storage 108 is a network storage device capable of storing any type of data in a structured format or an unstructured format. In addition, storage 108 may represent a plurality of network storage devices. Further, storage 108 may represent an employee retention insights database of the employee retention insight services provider that contains a plurality of different employee retention insights and reports corresponding to the plurality of different employer entities. Furthermore, storage 108 may store other types of data, such as authentication or credential data that may include user names, passwords, and biometric data associated with system administrators and human resource users, for example.

In addition, it should be noted that network data processing system 100 may include any number of additional servers, clients, storage devices, and other devices not shown. For example, network data processing system 100 may include a plurality of clients corresponding to each of the plurality of employer entities. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, a wide area network (WAN), a telecommunications network, or any combination thereof. FIG. 1 is intended as an example only, and not as an architectural limitation for the different illustrative embodiments.

As used herein, when used with reference to items, “a number of means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

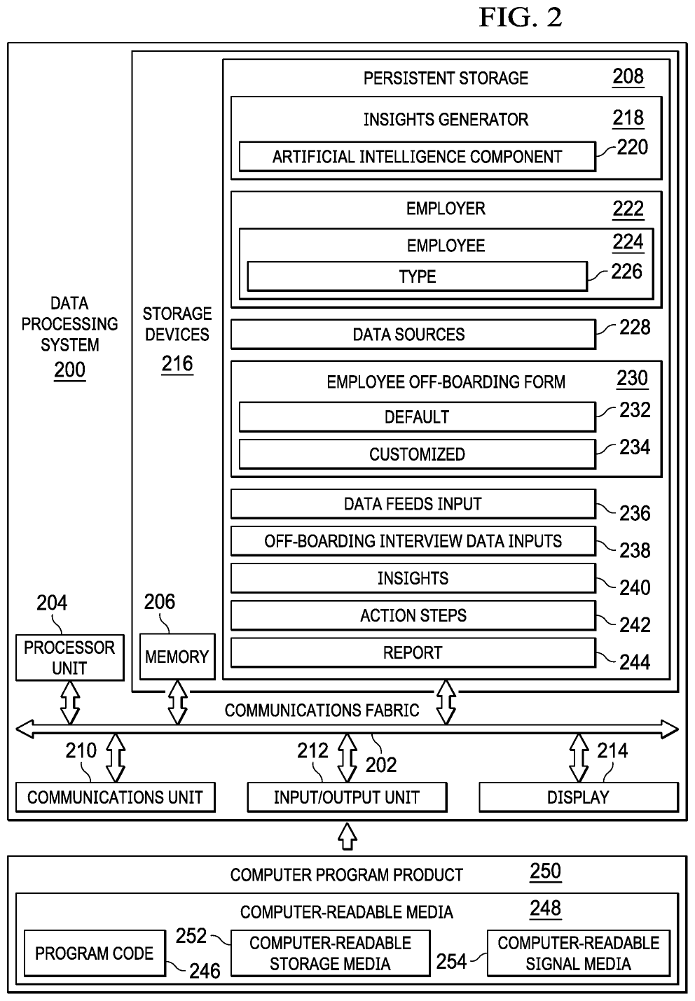

With reference now to FIG. 2, a diagram of a data processing system is depicted in accordance with an illustrative embodiment. Data processing system 200 is an example of a computer, such as server 104 in FIG. 1, in which computer readable program code or instructions implementing the employee retention insights generation processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer readable storage device or computer readable storage medium is any piece of hardware that is capable of storing information, such as, for example, without limitation, data, computer readable program instructions in functional form, and/or other suitable information either on a transient basis or a persistent basis. Further, a computer readable storage device or computer readable storage medium excludes a propagation medium, such as a transitory signal. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores insights generator 218. However, it should be noted that even though insights generator 218 is illustrated as residing in persistent storage 208, in an alternative illustrative embodiment insights generator 218 may be a separate component of data processing system 200. For example, insights generator 218 may be a hardware component coupled to communication fabric 202 or a combination of hardware and software components. In another alternative illustrative embodiment, a first set of components of insights generator 218 may be located in data processing system 200 and a second set of components of insights generator 218 may be located in a second data processing system, such as, for example, server 106 in FIG. 1.

Insights generator 218 controls the process of generating insights into employee retention steps from employee off-boarding data using artificial intelligence component 220. An artificial intelligence component is a system that has intelligent behavior and can be based on the function of a human brain. An artificial intelligence component comprises at least one of an artificial neural network, cognitive system, Bayesian network, fuzzy logic, expert system, natural language system, or some other suitable system. Machine learning can be used to train the artificial intelligence component. Machine learning involves inputting data to the process and allowing the process to adjust and improve the function of the artificial intelligence component.

A machine learning model is a type of artificial intelligence component that can learn without being explicitly programmed. A machine learning model can learn based on training data input into the machine learning model. The machine learning model can learn using various types of machine learning algorithms. The machine learning algorithms include at least one of a supervised learning, unsupervised learning, feature learning, sparse dictionary learning, anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

Employer 222 represents an identifier of a particular employer entity that employs a multitude of employees. However, it should be noted that employer 222 only represents one particular employer entity of a plurality of different employer entities registered for the employee retention insight services provided by data processing system 200, which is operated by the employer retention insight services provider. Employee 224 represents an identifier of a particular employee of the multitude of employees leaving employer 222. Type 226 represents an identifier of the position, class, category, or kind of employee for employer 222 corresponding to employee 224. For example, type 226 may be an executive, a manager, a staff member, a designer, a programmer, or the like.

Data sources 228 represent identifiers for a plurality of different sources of employee and employer information. For example, the plurality of different data sources may include, for example, employer 222's human resources database containing human resource information corresponding to the multitude of employees of employer 222, such as names, identifiers, positions, duties, start dates, lengths of employment, wages, wage increases, promotions, demotions, commendations, awards, reprimands, work attitude, employee complaints, and the like. The plurality of different data sources may also include one or more databases maintained by different third-party entities containing ratings and rankings information corresponding to a plurality of different employers based on surveys of current and former employees. The plurality of different data sources may further include a historical employee off-boarding database maintained by the employee retention insight services provider that contains all historical employee off-boarding data.

Employee off-boarding form 230 is a digital or electronic input form for obtaining information regarding possible reasons and motivations of employees leaving an employer. Initially, employee off-boarding form 230 is in default 232 form. After insights generator 218 receives an input from a client device, such as client 110 in FIG. 1, corresponding to a human resource user associated with employer 222 to initiate an employee off-boarding process for employee 224, insights generator 218 transforms employee off-boarding form 230 from default 232 to customized 234. Insights generator 218 transforms employee off-boarding form 230 into a form that is specifically customized to employer 222 and type 226 of employee 224 in order to develop detailed and accurate insights into employee 224's exit from employee 222 for a particular position.

Insights generator 218, using artificial intelligence component 220, pre-populates certain fields of customized employee off-boarding form 230 using data feeds inputs 236. The certain fields are those input fields of the form that artificial intelligence component 220 can automatically fill in with needed information. Data feeds inputs 236 represent inputted information into customized employee off-boarding form 230 that was received from data sources 308, which includes employer human resources data, third-party employer data, historical employee off-boarding data, and the like.

After pre-populating customized employee off-boarding form 230 corresponding to employer 222 for type 226 of employee 224, insights generator 218 displays customized employee off-boarding form 230 with certain fields pre-populated on the client device of the human resource user and a client device, such as, for example, client 112 in FIG. 1, corresponding to employee 224 prior to and/or during an exit interview between the human resource user and employee 224. Subsequently, insights generator 218 receives off-boarding interview data inputs 238 in customized employee off-boarding form 230 from at least one of the human resource user and employee 224 to create a completed employee off-boarding form 230.

Insights generator 218, using artificial intelligence component 220, generates insights 240 into possible employee retention actions for employee 224's particular position (i.e., type 226) based on artificial intelligence component 220 analyzing the information included in completed employee off-boarding form 230 and data feeds from data sources 228. Insights 240 represent understanding or value obtained or gained through the use of machine learning analytics by artificial intelligence component 220 to understand employee retention. Insights 240 may include, for example, ways to decrease turnover for employee 224's particular position, ways to increase career path growth for employee 224's particular position, incentives to retain other employees or attract new employees for employee 224's particular position, possible employee benefits to induce employees to remain at employee 224's particular position, and the like.

Further, insights generator 218, using artificial intelligence component 220, generates action steps 242 based on completed employee off-boarding form 230 and insights 240. Artificial intelligence component 220 can automatically perform one or more of action steps 242 using defined application programming interfaces to connect to and control other applications, programs, components, systems, and the like. Action steps 242 may include, for example, at least one of automatically implementing employee retention actions, removing employee 224 from the current employee database, stopping payroll for employee 224 after a final paycheck is issued, removing access (e.g., credentials) of employee 224 to secure resources of employer 222, closing work-related accounts (e.g., email) corresponding to employee 224, terminating benefits (e.g., 401k employer matching contributions) corresponding to employee 224, reassigning work-related tasks of employee 224 to other employees, and the like.

Furthermore, insights generator 218, using artificial intelligence component 220, generates report 244. Report 244 is an employee retention action report, which includes insights 240. Insights generator 218 sends report 244 to the human resource user and saves report 244 in an employee retention insights database.

As a result, data processing system 200 operates as a special purpose computer system in which insights generator 218 in data processing system 200 enables generation of insights into specific employee retention actions for a particular employee position of a particular employer. In particular, insights generator 218 transforms data processing system 200 into a special purpose computer system as compared to currently available general computer systems that do not have insights generator 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 246 is located in a functional form on computer readable media 248 that is selectively removable and may be loaded onto or transferred to data processing system 200 for running by processor unit 204. Program code 246 and computer readable media 248 form computer program product 250. In one example, computer readable media 248 may be computer readable storage media 252 or computer readable signal media 254.

In these illustrative examples, computer readable storage media 253 is a physical or tangible storage device used to store program code 246 rather than a medium that propagates or transmits program code 246. In other words, computer readable storage media 252 exclude a propagation medium, such as transitory signals. Computer readable storage media 252 may include, for example, an optical or magnetic disc that is inserted or placed into a drive or other device that is part of persistent storage 208 for transfer onto a storage device, such as a hard drive, that is part of persistent storage 208. Computer readable storage media 252 also may take the form of a persistent storage, such as a hard drive, a thumb drive, or a flash memory that is connected to data processing system 200.

Alternatively, program code 246 may be transferred to data processing system 200 using computer readable signal media 254. Computer readable signal media 254 may be, for example, a propagated data signal containing program code 246. For example, computer readable signal media 254 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 248” can be singular or plural. For example, program code 246 can be located in computer readable media 248 in the form of a single storage device or system. In another example, program code 246 can be located in computer readable media 248 that is distributed in multiple data processing systems. In other words, some instructions in program code 246 can be located in one data processing system while other instructions in program code 246 can be located in one or more other data processing systems. For example, a portion of program code 246 can be located in computer readable media 248 in a server computer while another portion of program code 246 can be located in computer readable media 248 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 246.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Currently, when an employee leaves an employer, the employee typically attends an exit interview with a human resource person or agent to explain the reasons or motivations for leaving. The human resource interviewer takes notes during the exit interview trying to get an understanding of the employee's reasons or motivations for leaving and then archives that employee exit interview data. However, this is a long and manual process to gather, prepare, and categorize all of the exit interview data for future analysis. In addition, insights into the data are dependent on the knowledge and expertise of the human resource personnel involved in the exit interviews and the data preparation and analysis process. In other words, actual insights may not be optimal due to limitations of the person-to-person information flow and the human-centric data gathering, preparing, and analysis procedures. Further, current insight applications do not provide clear and direct insights regarding employee retention based on exit interview data and multiple sources of other employer/employee-related data.

Illustrative embodiments utilize employee off-boarding data to generate employee retention insights for an employer entity, such as, for example, a corporation, a company, a business, an enterprise, an organization, an institution, an agency, or the like, turning these insights into an opportunity for new employee retention actions. Illustrative embodiments provide a dynamic and customizable, both by an artificial intelligence component, itself, and human resource personnel, digital employee off-boarding form to collect the off-boarding interview data. The artificial intelligence component prepares and processes the information in the digital off-boarding form, along with other data retrieved from multiple data sources, such as, for example, employer human resource data, external third-party employer data, historical employee off-boarding data, and the like. Then, the artificial intelligence component generates insights that may provide guidance for employee retention actions, such as, for example, defining steps on how to decrease employee turnover, determining employee career growth stimuli, designing new employee benefit plans, and the like.

Thus, illustrative embodiments can provide on demand, user-driven insights for when human resource personnel desire employee retention action reports with insights. Illustrative embodiments can also automatically provide event-driven insights every time an employee leaves an employer, on a defined time interval basis (e.g. quarterly), or based on some other predefined condition. Further, illustrative embodiments can also provide data-driven insights in response to the artificial intelligence component identifying pattern changes in employee off-boarding data in such a way that the artificial intelligence component understands it is appropriate to alert human resource personnel regarding those data pattern changes.

The artificial intelligence component of illustrative embodiments not only “presents data” for a particular employee position, such as an engineering technician in the business services industry during a particular time period in a particualr region or country (e.g., total compesation for that particular position, bonus percentage of total compensation, overtime percentage of total compensation, turnover rate, and the like) and “asks questions” (e.g., regarding total compensation: “How do you structure your compensation to be competitive in the market?” and “Do you know what the market rates of compensation are currently and how you compare to those market rates?”; regarding bonus percentage of total compensation: “Do you feel like you have a good sense of what the optimal bonus levels should be for the position?” and “Would market data help you refine your compensation strategy?”; regarding overtime percentage of total compensation: “Do you have unanticipated blocks of overtime that you feel are difficult to manage?” and “Would you like to better understand how other organizations use overtime for the position?”; and regarding turnover rate: “Do you understand drivers of turnover for the position?” and “Do you know if you're losing employees in the position faster than the competition?”). Furthermore, the artificial intelligence component also provides answers to those questions. Answers to those questions may be, for example, “Your regional competitors have lowered the overtime pay needs by 15% in the last year and increased total compensation for this position by 4%. In the same period, your regional competitors' turnover rate dropped by 5%. Consider redesigning benefit plans for this position in order to cover dependent dental care expenses with 40% or less employee co-participation.”

The artificial intelligence component utilizes data in the employee retention insights database for developing employee retention actions, generating individual and group turnover prevention initiatives, improving the digital employee off-boarding form and exit interview process, enhancing employee benefit plans, analyzing and presenting historical employee turnover and retention data; and the like. Data formats of the employee retention insights database may include, for example, a tabular data format, a spreadsheet format, a chart format, a markup format, and the like, which are human-readable data formats. Other data sources for the artificial intelligence component include, for example, data input into the employee off-boarding form, historical employee off-boarding data, and employer-related and competitor-related data, such as: payroll information (e.g., last time employee had a raise in salary, total compensation, bonuses, overtime, absenteeism, and the like); benefits information (e.g., employee contributions, enrolled versus available benefits, and the like); career tracking data (e.g., employee personal strengths, employee team strengths, disciplinary actions, bonus multipliers achieved, and the like); external third-party employer data via defined application programming interfaces (e.g., employer number of ratings and overall rating, employer compensation and benefits rating, employer career opportunity rating, and the like); and employee survey data regarding employer culture and the like. The artificial intelligence component may perform, for example, data scraping, data mining, data transformation, machine learning, and the like, to collect and analyze the employee off-boarding data. Illustrative embodiments train the artificial intelligence component using the historical employee off-boarding data to create a specialized machine learning model that determines employee retention insights and action steps for respective employers for particular employee positions. As a result, the specialized machine learning model increases the performance and accuracy of the artificial intelligence component's analytical and predictive capabilities, thereby increasing the performance of the computer, itself.

Thus, illustrative embodiments provide one or more technical solutions that overcome a technical problem with determining employee retention actions for a particular employee position using artificial intelligence. As a result, these one or more technical solutions provide a technical effect and practical application in the field of artificial intelligence.

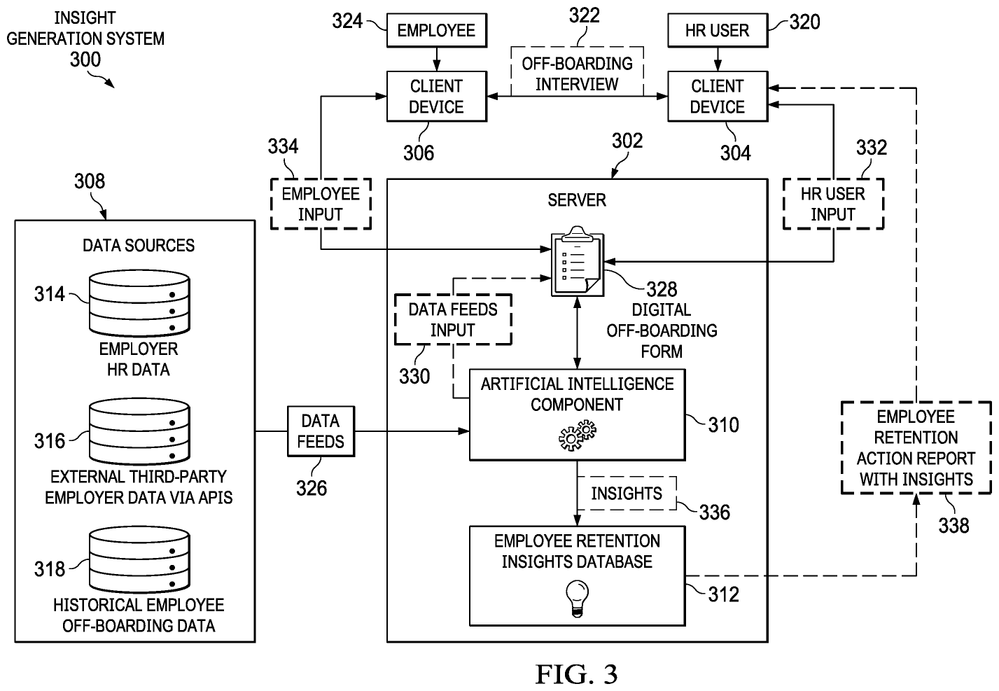

With reference now to FIG. 3, a diagram illustrating an example of an insight generation system is depicted in accordance with an illustrative embodiment. Insight generation system 300 may be implemented in a network of data processing systems, such as network data processing system 100 in FIG. 1. Insight generation system 300 is a system of hardware and software components for generating insights into employee retention actions for a particular employee position using artificial intelligence.

In this example, insight generation system 300 includes server 302, client device 304, client device 306, and data sources 308. However, it should be noted that insight generation system 300 is only intended as an example and not as a limitation on illustrative embodiments. In other words, insight generation system 300 may include any number of servers, clients, data sources, and other devices, components, systems, and the like, not shown.

Server 302 may be, for example, server 104 in FIG. 1 or data processing system 200 in FIG. 2. Server 302 includes artificial intelligence component 310, such as artificial intelligence component 220 in FIG. 2. Server 302 also includes employee retention insights database 312.

In this example, data sources 308 include employer human resources database 314, external third-party employer data via application programming interfaces 316, and historical employee off-boarding data 318. However, data sources 308 may include any type of employer/employee data sources.

Human resource user 320 corresponding to client device 304 conducts off-boarding interview 322 with employee 324 via client device 306. Employee 324 may be, for example, employee 224 of employer 222 in FIG. 2. Employee 324 is currently leaving the employer.

Upon initiation of the employee off-boarding process by human resource user 320, artificial intelligence component 310 collects data feeds 326 from data sources 308. Artificial intelligence component 310 pre-populates certain fields of digital off-boarding form 328 using data feeds input 330, which is based on the information contained in data feeds 326. Digital off-boarding form 328 may be, for example, employee off-boarding form 230 in FIG. 2. Human resource user 320 also populates fields of digital off-boarding form 328 using human resource user input 332 via client device 304 based on off-boarding interview 322. Employee 324 may also populate fields in digital off-boarding form 328 using employee input 334 via client device 306. However, employee input 334 is optional.

Based on completed digital off-boarding form 328 and the information in data feeds 326, artificial intelligence component 310 generates insights 336. Insights 336 may be, for example, insights 240 in FIG. 2. Artificial intelligence component 310 stores insights 336 in employee retention insights database 312. Moreover, artificial intelligence component 310 generates employee retention action report with insights 338. Employee retention action report with insights 338 may be, for example, report 244 in FIG. 2. Artificial intelligence component 310 sends employee retention action report with insights 338 to human resource user 320 via client device 304. Alternatively, human resource user 320 may retrieve insights 336 from employee retention insights database 312 and consult insights 336 on demand.

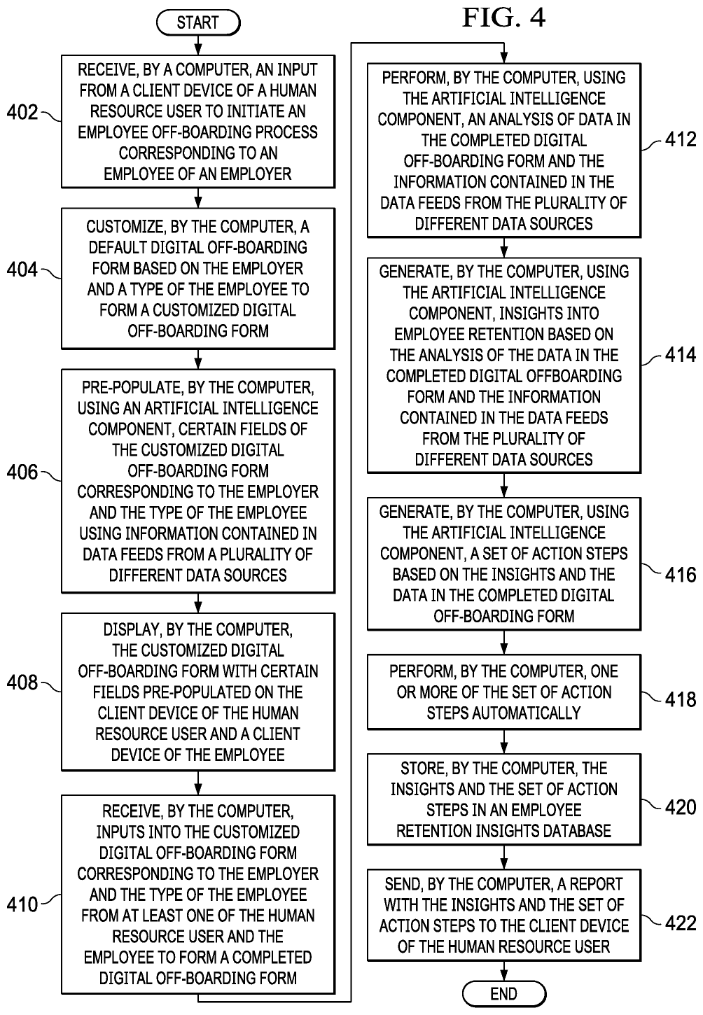

With reference now to FIG. 4, a flowchart illustrating a process for generating employee retention insights is shown in accordance with an illustrative embodiment. The process shown in FIG. 4 may be implemented in a computer, such as, for example, server 104 in FIG. 1 or data processing system 200 in FIG. 2. For example, the process can be implemented in insights generator 218 in FIG. 2.

The process begins when the computer receives an input from a client device of a human resource user to initiate an employee off-boarding process corresponding to an employee of an employer (step 402). In other words, the employee is leaving the employer and a person from the human resources department is to conduct an exist interview with the employee. In response to receiving the input to initiate the employee off-boarding process, the computer customizes a default digital off-boarding form based on the employer and a type of the employee to form a customized digital off-boarding form (step 404). In other words, the computer transforms the default digital off-boarding form into a different state or thing forming the customized digital off-boarding form based on the particular employer (i.e., name of the employer) and the type of the employee (e.g., worker, contract worker, staff, manager, executive, officer, director, or the like).

Afterward, the computer, using an artificial intelligence component, pre-populates certain fields of the customized digital off-boarding form corresponding to the employer and the type of the employee using information contained in data feeds from a plurality of different data sources (step 406). The computer then displays the customized digital off-boarding form with certain fields pre-populated on the client device of the human resource user and a client device of the employee (step 408). Subsequently, the computer receives inputs into the customized digital off-boarding form corresponding to the employer and the type of the employee from at least one of the client device of the human resource user and the client device of the employee to form a completed digital off-boarding form (step 410).

The computer, using the artificial intelligence component, performs an analysis of data in the completed digital off-boarding form and the information contained in the data feeds from the plurality of different data sources (step 412). The computer, using the artificial intelligence component, generates insights into employee retention based on the analysis of the data in the completed digital off-boarding form and the information contained in the data feeds from the plurality of different data sources (step 414). In addition, the computer, using the artificial intelligence component, generates a set of action steps based on the insights and the data in the completed digital off-boarding form (step 416).

The computer performs one or more of the set of action steps automatically (step 418). Further, the computer stores the insights and the set of action steps in an employee retention insights database (step 420). Furthermore, the computer sends a report with the insights and the set of action steps to the client device of the human resource user (step 422). However, it should be noted that the human resource user may retrieve and consult the insights from the employee retention insights database at any time on demand. Thereafter, the process terminates.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, illustrative embodiments of the present invention provide a computer-implemented method, computer system, and computer program product for generating employee retention insights from employee off-boarding data using artificial intelligence for employee retention actions. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for generating employee retention insights, the computer-implemented method comprising:
performing, by a computer, using an artificial intelligence component, an analysis of data in a completed digital off-boarding form corresponding to a particular employer and a type of a particular employee leaving the particular employer and information in data feeds from a plurality of different data sources;
generating, by the computer, using the artificial intelligence component, insights into employee retention for the type of the particular employee corresponding to the particular employer based on the analysis of the data in the completed digital off-boarding form and the information in the data feeds from the plurality of different data sources;
generating, by the computer, using the artificial intelligence component, a set of action steps based on the insights and the data in the completed digital off-boarding form; and
performing, by the computer, one or more of the set of action steps automatically, wherein the artificial intelligence component is trained using historical employee off-boarding data to create a specialized machine learning model that determines the employee retention insights and the action steps for respective employers for particular employee types, and wherein the specialized machine learning model increases performance and accuracy regarding analytical and predictive capabilities of the artificial intelligence component thereby increasing performance of the computer, itself.

2. The computer-implemented method of claim 1 further comprising:
storing, by the computer, the insights and the set of action steps in an employee retention insights database; and
sending, by the computer, a report with the insights and the set of action steps to a client device corresponding to a human resource user.

3. The computer-implemented method of claim 1 further comprising:
receiving, by the computer, an input from a client device of a human resource user to initiate an employee off-boarding process corresponding to the particular employee leaving the particular employer; and
responsive to receiving the input to initiate the employee off-boarding process, customizing, by the computer, a default digital off-boarding form based on the particular employer and the type of the particular employee to form a customized digital off-boarding form.

4. The computer-implemented method of claim 3 further comprising:
pre-populating, by the computer, using the artificial intelligence component, certain fields of the customized digital off-boarding form corresponding to the particular employer and the type of the particular employee using the information in the data feeds from the plurality of different data sources; and
displaying, by the computer, the customized digital off-boarding form with certain fields pre-populated on the client device corresponding to the human resource user of the particular employer and a client device corresponding to the particular employee.

5. The computer-implemented method of claim 4 further comprising:
receiving, by the computer, inputs into the customized digital off-boarding form corresponding to the particular employer and the type of the particular employee from at least one of the client device of the human resource user and the client device of the particular employee to form the completed digital off-boarding form.

6. The computer-implemented method of claim 1, wherein the plurality of different data sources includes a database of the particular employer containing human resource data corresponding to employees of the particular employer, third-party databases containing employer rating and ranking data obtained from current and former employees using surveys, and a database of an employee retention insight services provider containing historical employee off-boarding data.

7. The computer-implemented method of claim 1, wherein the employee retention insights include steps for decreasing employee turnover for the type of the particular employee, steps for increasing employee career growth for the type of the particular employee, and steps to implement new employee benefit plans for the type of the particular employee.

8. The computer-implemented method of claim 1, wherein the type of the particular employee is a position, class, category, or kind of employee for the particular employer.

9. The computer-implemented method of claim 1, wherein the action steps include at least one of automatically implementing employee retention actions, removing the particular employee from a current employee database, stopping payroll for the particular employee after a final paycheck is issued, removing access of the particular employee to secure resources of the particular employer, closing work-related accounts corresponding to the particular employee, terminating benefits corresponding to the particular employee, and reassigning work-related tasks of the particular employee to other employees.

10. (canceled)

11. A computer system for generating employee retention insights, the computer system comprising:
a bus system;
a storage device connected to the bus system, wherein the storage device stores program instructions; and
a processor connected to the bus system, wherein the processor executes the program instructions to:
perform, using an artificial intelligence component, an analysis of data in a completed digital off-boarding form corresponding to a particular employer and a type of a particular employee leaving the particular employer and information in data feeds from a plurality of different data sources;
generate, using the artificial intelligence component, insights into employee retention for the type of the particular employee corresponding to the particular employer based on the analysis of the data in the completed digital off-boarding form and the information in the data feeds from the plurality of different data sources;
generate, using the artificial intelligence component, a set of action steps based on the insights and the data in the completed digital off-boarding form; and
perform one or more of the set of action steps automatically, wherein the artificial intelligence component is trained using historical employee off-boarding data to create a specialized machine learning model that determines the employee retention insights and the action steps for respective employers for particular employee types, and wherein the specialized machine learning model increases performance and accuracy regarding analytical and predictive capabilities of the artificial intelligence component thereby increasing performance of the computer system, itself.

12. The computer system of claim 11, wherein the processor further executes the program instructions to:
store the insights and the set of action steps in an employee retention insights database; and
send a report with the insights and the set of action steps to a client device corresponding to a human resource user.

13. The computer system of claim 11, wherein the processor further executes the program instructions to:
receive an input from a client device of a human resource user to initiate an employee off-boarding process corresponding to the particular employee leaving the particular employer; and
customize a default digital off-boarding form based on the particular employer and the type of the particular employee to form a customized digital off-boarding form in response to receiving the input to initiate the employee off-boarding process.

14. The computer system of claim 13, wherein the processor further executes the program instructions to:
pre-populate, using the artificial intelligence component, certain fields of the customized digital off-boarding form corresponding to the particular employer and the type of the particular employee using the information in the data feeds from the plurality of different data sources; and
displaying, by the computer, the customized digital off-boarding form with certain fields pre-populated on the client device corresponding to the human resource user of the particular employer and a client device corresponding to the particular employee.

15. The computer system of claim 14, wherein the processor further executes the program instructions to:
receive inputs into the customized digital off-boarding form corresponding to the particular employer and the type of the particular employee from at least one of the client device of the human resource user and the client device of the particular employee to form the completed digital off-boarding form.

16. The computer system of claim 11, wherein the plurality of different data sources includes a database of the particular employer containing human resource data corresponding to employees of the particular employer, third-party databases containing employer rating and ranking data obtained from current and former employees using surveys, and a database of an employee retention insight services provider containing historical employee off-boarding data.

17. The computer system of claim 11, wherein the employee retention insights include steps for decreasing employee turnover for the type of the particular employee, steps for increasing employee career growth for the type of the particular employee, and steps to implement new employee benefit plans for the type of the particular employee.

18. The computer system of claim 11, wherein the type of the particular employee is a position, class, category, or kind of employee for the particular employer.

19. The computer system of claim 11, wherein the action steps include at least one of automatically implementing employee retention actions, removing the particular employee from a current employee database, stopping payroll for the particular employee after a final paycheck is issued, removing access of the particular employee to secure resources of the particular employer, closing work-related accounts corresponding to the particular employee, terminating benefits corresponding to the particular employee, and reassigning work-related tasks of the particular employee to other employees.

20. (canceled)

21. A computer program product for generating employee retention insights, the computer program product comprising a computer readable storage medium having program instructions embodied therewith, the program instructions executable by a computer to cause the computer to perform a method of:
performing, by the computer, using an artificial intelligence component, an analysis of data in a completed digital off-boarding form corresponding to a particular employer and a type of a particular employee leaving the particular employer and information in data feeds from a plurality of different data sources;
generating, by the computer, using the artificial intelligence component, insights into employee retention for the type of the particular employee corresponding to the particular employer based on the analysis of the data in the completed digital off-boarding form and the information in the data feeds from the plurality of different data sources;
generating, by the computer, using the artificial intelligence component, a set of action steps based on the insights and the data in the completed digital off-boarding form; and
performing, by the computer, one or more of the set of action steps automatically, wherein the artificial intelligence component is trained using historical employee off-boarding data to create a specialized machine learning model that determines the employee retention insights and the action steps for respective employers for particular employee types, and wherein the specialized machine learning model increases performance and accuracy regarding analytical and predictive capabilities of the artificial intelligence component thereby increasing performance of the computer, itself.

22. The computer program product of claim 21 further comprising:
storing, by the computer, the insights and the set of action steps in an employee retention insights database; and
sending, by the computer, a report with the insights and the set of action steps to a client device corresponding to a human resource user.

23. The computer program product of claim 21 further comprising:
receiving, by the computer, an input from a client device of a human resource user to initiate an employee off-boarding process corresponding to the particular employee leaving the particular employer; and
responsive to receiving the input to initiate the employee off-boarding process, customizing, by the computer, a default digital off-boarding form based on the particular employer and the type of the particular employee to form a customized digital off-boarding form.

24. The computer program product of claim 23 further comprising:
pre-populating, by the computer, using the artificial intelligence component, certain fields of the customized digital off-boarding form corresponding to the particular employer and the type of the particular employee using the information in the data feeds from the plurality of different data sources; and
display the customized digital off-boarding form with certain fields pre-populated on the client device corresponding to the human resource user of the particular employer and a client device corresponding to the particular employee.

25. The computer program product of claim 24 further comprising:
receiving, by the computer, inputs into the customized digital off-boarding form corresponding to the particular employer and the type of the particular employee from at least one of the client device of the human resource user and the client device of the particular employee to form the completed digital off-boarding form.

26. The computer program product of claim 21, wherein the plurality of different data sources includes a database of the particular employer containing human resource data corresponding to employees of the particular employer, third-party databases containing employer rating and ranking data obtained from current and former employees using surveys, and a database of an employee retention insight services provider containing historical employee off-boarding data.

27. The computer program product of claim 21, wherein the employee retention insights include steps for decreasing employee turnover for the type of the particular employee, steps for increasing employee career growth for the type of the particular employee, and steps to implement new employee benefit plans for the type of the particular employee.

28. The computer program product of claim 21, wherein the type of the particular employee is a position, class, category, or kind of employee for the particular employer.

29. The computer program product of claim 21, wherein the action steps include at least one of automatically implementing employee retention actions, removing the particular employee from a current employee database, stopping payroll for the particular employee after a final paycheck is issued, removing access of the particular employee to secure resources of the particular employer, closing work-related accounts corresponding to the particular employee, terminating benefits corresponding to the particular employee, and reassigning work-related tasks of the particular employee to other employees.

30. (canceled)

31. A method for generating employee retention insights, the method comprising:
performing an analysis of data in a completed digital off-boarding form corresponding to a particular employer and a type of a particular employee leaving the particular employer and information in data feeds from a plurality of different data sources;
generating insights into employee retention for the type of the particular employee corresponding to the particular employer based on the analysis of the data in the completed digital off-boarding form and the information in the data feeds from the plurality of different data sources; and
performing a set of action steps automatically based on the insights and the data in the completed digital off-boarding form.
